(19) United States
(12) Patent Application Publication
(10) Pub. No.: US 2025/0235792 A1
(43) Pub. Date: Jul. 24, 2025

(54) SYSTEMS AND METHODS FOR DYNAMICALLY GENERATING NONPLAYER CHARACTER INTERACTIONS ACCORDING TO PLAYER INTERESTS

(71) Applicant: Sony Interactive Entertainment Inc., Tokyo (JP)

(72) Inventors: Liting Niou, Milpitas, CA (US); Edward Cheung, Castro Valley, CA (US)

(21) Appl. No.: 18/421,882

(22) Filed: Jan. 24, 2024

(51) Int. Cl. A63F 13/67; A63F 13/79

(52) U.S. Cl. CPC A63F 13/67; A63F 13/79

(57) ABSTRACT

Systems and methods for generating nonplayer character (NPC) interactions according to player interests are described. One of the methods includes receiving data from one or more user accounts indicative of interest of a player, training a nonplayer character in the game based on the data to output a trained nonplayer character, and determining whether a game state for triggering a communication from the nonplayer character is generated. The method includes controlling the trained nonplayer character to output the communication during the game upon determining that the game state is generated.

### FIELD

The present disclosure relates to systems and methods for dynamically generating nonplayer character interactions according to player interests are described.

### BACKGROUND

In a game system, one or more servers are coupled to many gaming devices via the Internet. Each gaming device is controlled by a player. The player accesses a game via the Internet and a gaming device to enjoy the game. During the game, the player encounters multiple tasks and controls the gaming device to achieve various goals in the game. The game includes many characters of different types. However, sometimes, the player gets bored and loses interest in the game.

It is in this context that embodiments of the invention arise.

### SUMMARY

Embodiments of the present disclosure provide systems and methods for dynamically generating nonplayer character interactions according to player interests.

Nonplayer characters (NPCs) are boring, and therefore, some users lose interest in a game. The systems and methods described herein examine and analyze user interactions with a network system, such as a social network system or a chat network system or a dating network system or a gaming network system or a combination of two or more thereof, to determine interests, including hobbies, of one or more users. An example of the gaming network system is a game cloud system. Upon determining the interests of the one or more users, the systems and methods described herein generate new storylines when interacting with the nonplayer characters that is closer to what the interests are of the one or more users or what makes them happy. For example, customized nonplayer character interactions with a user based on a user profile determined through public information, such as social media accounts, are generated by the game cloud system. As another example, the game cloud system dynamically changes virtual actions of the nonplayer characters to what the one or more users are most interested in. As another example, the AI model provides information to generate a personality of a nonplayer character that is customized to interests of a user. To illustrate, the nonplayer character can discuss qualities of a virtual product or service or feature in the game to increase interest of the user in the product or service or feature. The interests are determined from data that is linked to a social network account of the user. The data includes statements made by the user regarding the user's gaming experience during a chat session or an audio session with a social network friend of the user.

In an embodiment, a method for generating NPC interactions according to player interests is described. The method includes receiving data from one or more user accounts indicative of interest of a player, training a nonplayer character in the game based on the data to output a trained nonplayer character, and determining whether a game state for triggering a communication from the nonplayer character is generated. The method includes controlling the trained nonplayer character to output the communication during the game upon determining that the game state is generated.

In one embodiment, a server system for generating NPC interactions according to player interests is described. The server system includes a processor and a memory device. The processor receives data from one or more user accounts indicative of interest of a player, trains a nonplayer character in the game based on the data to output a trained nonplayer character, and determines whether a game state for triggering a communication from the nonplayer character is generated. The processor controls the trained nonplayer character to output the communication during the game upon determining that the game state is generated. The memory device is coupled to the processor.

In an embodiment, a system for generating NPC interactions according to player interests is described. The system includes a client device that receives, via one or more user accounts, data indicative of interest of a player. The system further includes a server coupled to the client device via a computer network. The server accesses the data received via the one or more user accounts, trains a nonplayer character in the game based on the data to output a trained nonplayer character, and determines whether a game state for triggering a communication from the nonplayer character is generated. The server controls the trained nonplayer character to output the communication during the game upon determining that the game state is generated.

Some advantages of the herein described systems and methods include increasing user interest in a game by training and controlling one or more nonplayer characters of the game. Actions performed by the one or nonplayer characters of the game can be boring to a user. By using artificial intelligence model to determine whether the actions performed by the one or nonplayer characters are of interest or boring to the user, the nonplayer characters can be controlled to perform actions that are of interest to the user.

Additional advantages of the herein described systems and methods include unlocking computer functionality by controlling the one or more nonplayer characters to perform actions that are of interest to the user. When the nonplayer characters perform actions that are of little interest or no interest to the user, the user usually ends up quitting the game. When the user quits the game, many features of the game remained locked and therefore computer functionality to execute the features remains hidden. By determining actions of the nonplayer characters that are of interest to the user, complex features of the game are unlocked. The complex features are unlocked using the computer functionality and therefore the computer functionality is unlocked. When the computer functionality is unlocked, performance of the computer can be analyzed in a better manner compared to when the computer functionality remains locked.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRA WINGS

Various embodiments of the present disclosure are best understood by reference to the following description taken in conjunction with the accompanying drawings in which:

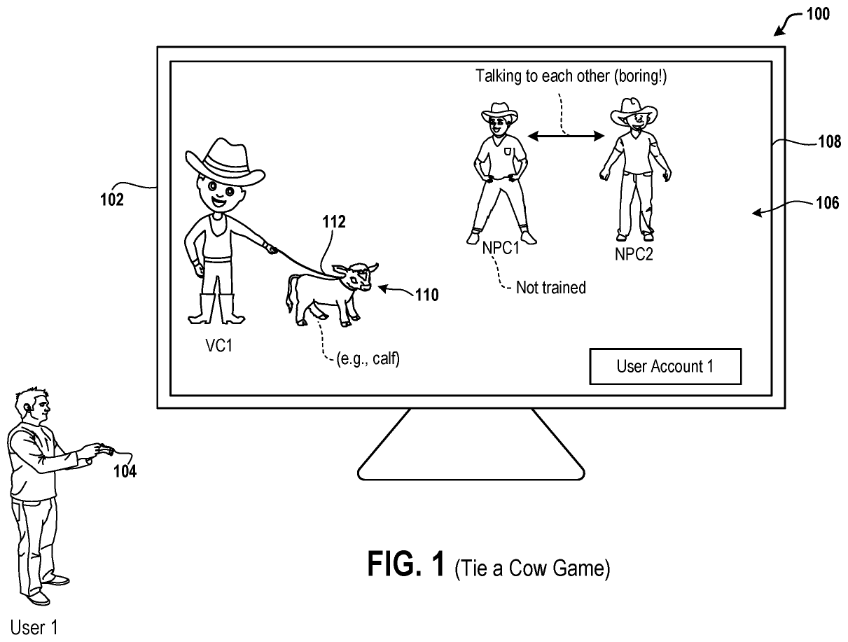

FIG. 1 is an embodiment of a system to illustrate that communication between nonplayer characters is boring to a user during a play of a game.

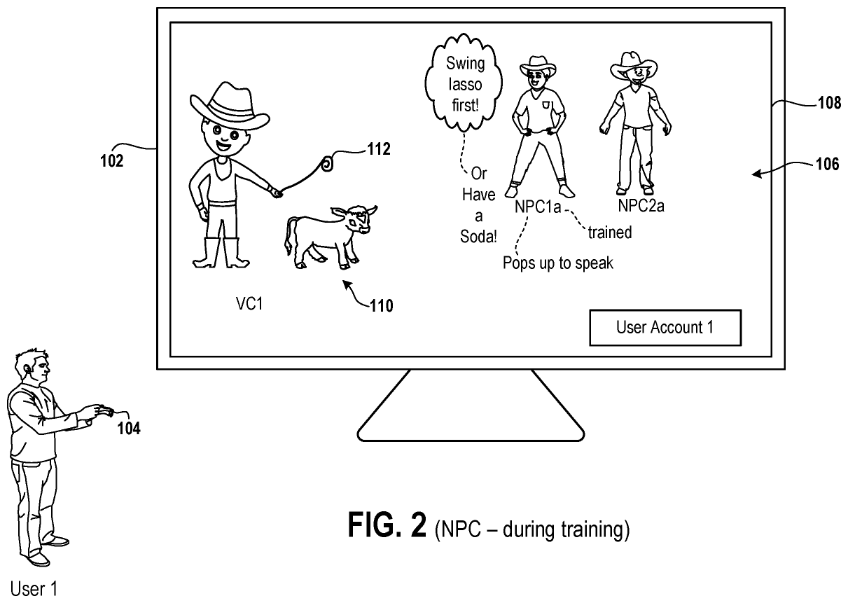

FIG. 2 is a diagram of an embodiment of a system to illustrate nonplayer characters during training of the nonplayer characters.

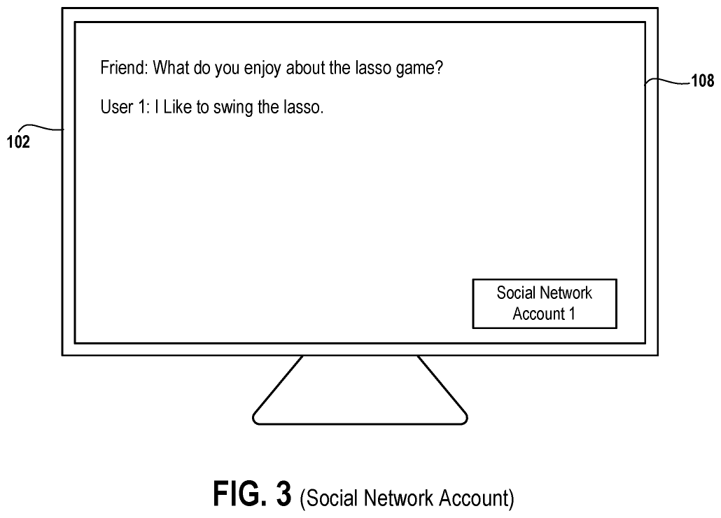

FIG. 3 is a diagram of an embodiment of a computing device to illustrate a determination of interests of the user.

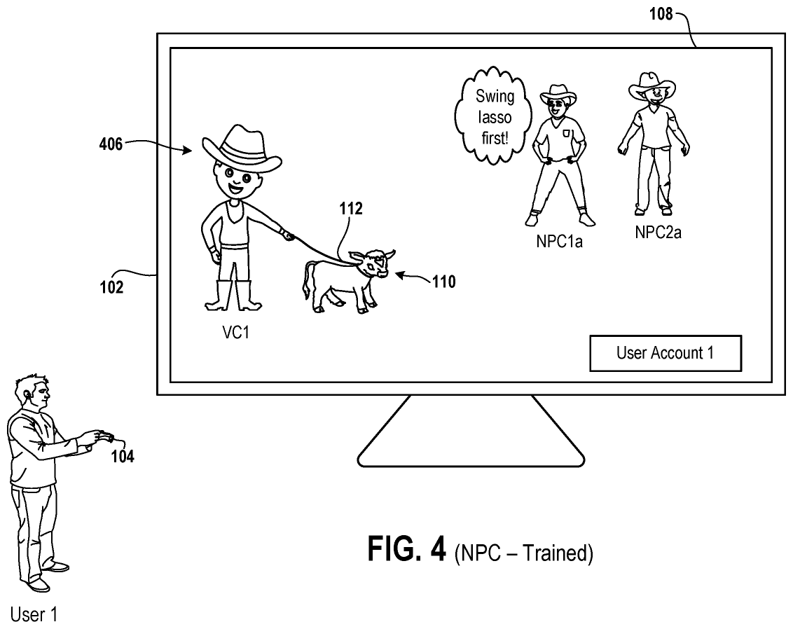

FIG. 4 is a diagram of an embodiment of the computing device to illustrate a virtual scene in which nonplayer characters have been trained by an artificial intelligence (AI) model.

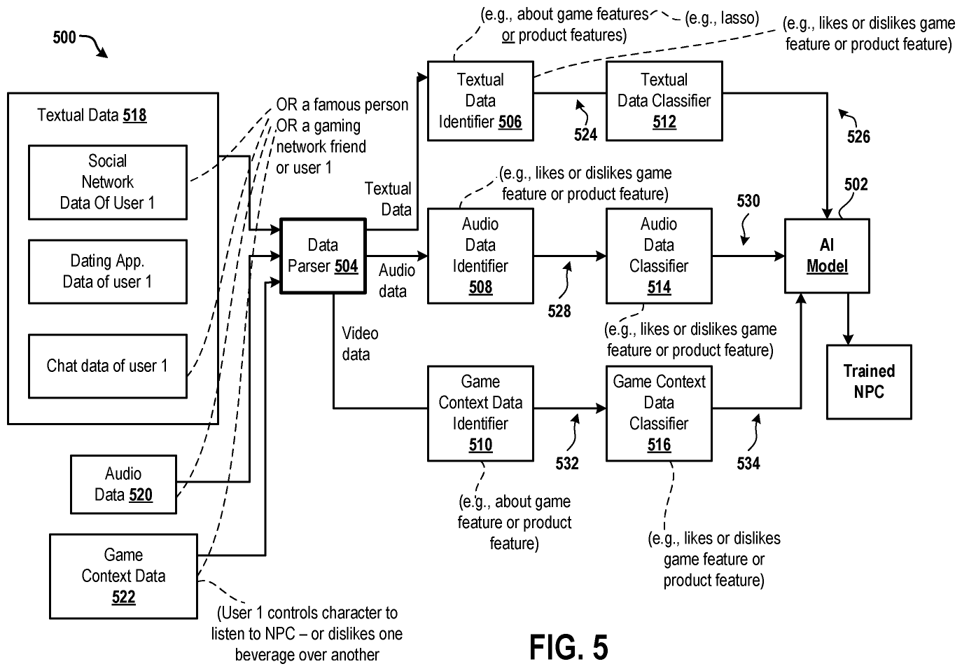

FIG. 5 is a diagram of an embodiment of a system to illustrate training of the AI model.

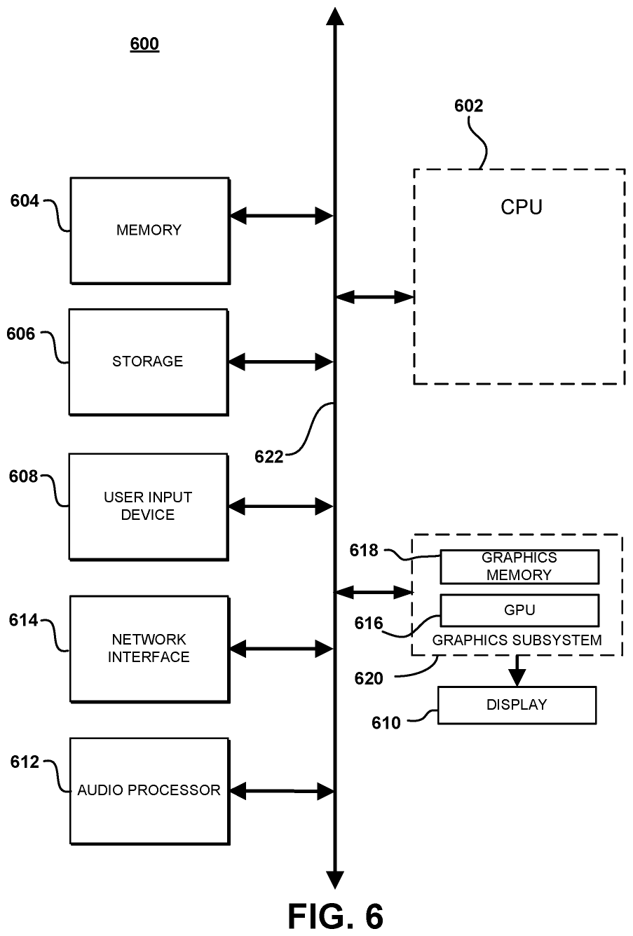

FIG. 6 illustrates components of an example device, such as a client device or a server system, described herein, that can be used to perform aspects of the various embodiments of the present disclosure.

### DETAILED DESCRIPTION

Systems and methods for dynamically generating nonplayer character interactions according to player interests are described. It should be noted that various embodiments of the present disclosure are practiced without some or all of these specific details. In other instances, well known process operations have not been described in detail in order not to unnecessarily obscure various embodiments of the present disclosure.

FIG. 1 is an embodiment of a system 100 to illustrate that communication between nonplayer characters NPC1 and NPC2 is boring to a user 1 during a play of a game. The system 100 includes a computing device 102 and a hand-held controller 104. An example of a computing device, as used herein, includes a combination of a television and a game console, or a computer, or a smartphone, or a smart television, or a head-mounted display (HMD), or a tablet. To illustrate, the computing device 102 includes one or more speakers to output sounds of the game. An example of a hand-held controller, as used herein, includes a game controller, such as a PS5™ game controller, or the smartphone.

The user 1 operates the hand-held controller 104 to access the game from a game cloud system, such as a server system. For example, the user 1 operates one or more buttons of the hand-held controller 104 to log into a user account 1, assigned to the user by the game cloud system. After logging into the user account 1, the user 1 further operates one or more buttons of the hand-held controller 104 to access the game. A user account assigned to a user to access the game is an example of a gaming account, such as a gaming network account. When the game is accessed, game state data for displaying a virtual environment 106 of the game is generated by the game cloud system and the virtual environment 106 is displayed on a display screen 108 by one or more processors of the computing device 102. Examples of a display screen include a plasma display, a liquid crystal display, and a light emitting diode display. The display screen 108 is a part of the computing device 102.

The virtual environment 106 has a virtual calf 110, which is an example of a virtual animal. The virtual animal is an example of a virtual character. The virtual environment 106 has another virtual character VC1 that is controlled by the user 1 via the user account 1 and one or more buttons of the hand-held controller 104. For example, the user 1 operates one or more buttons of the hand-held controller 104 to control movement of the virtual character VC1 in the virtual environment 106. To illustrate, the user 1 operates the hand-held controller 104 to position the virtual character VC1 to be close to the virtual calf 110. Moreover, in the example, the user 1 operates one or more buttons of the hand-held controller 104 to control the virtual character VC1 to perform one or more virtual activities, such as accessing a virtual lasso 112 from a set of virtual tools of the game, or catching the virtual calf 110 with the virtual lasso 112 by wrapping the virtual lasso 112 around a neck of the virtual calf 110, or a combination thereof.

The virtual environment 106 further includes the nonplayer characters NPC1 and NPC2. During a time period in which the user 1 controls the virtual character VC1 to perform the one or more virtual activities, the game cloud system controls the nonplayer characters NPC1 and NPC2 to engage in one or more virtual actions that are boring the user 1. For example, the nonplayer characters NPC1 and NPC2 are controlled to engage in a conversation with each other and the conversation is controlled by the game cloud system to be inaudible via the speakers of the computing device 102 to the user 1. To illustrate, independent of an amount of volume that is set by the user 1 to be output via the speakers of the computing device 102, the conversation is inaudible to a person. As another example, the nonplayer characters NPC1 and NPC2 are controlled to engage in a conversation with each other that is unrelated to use of features, such as access and movement the virtual lasso 112, of the game that are controllable the user 1. To illustrate, the nonplayer characters NPC1 and NPC2 discuss a topic such as weather or sports, that is unrelated to the performance of the one or more virtual activities. When the nonplayer characters NPC1 and NPC2 discuss the unrelated topic or engage in the conversation that is inaudible, the user 1 does not have interest in the conversation between the nonplayer characters NPC1 and NPC2. Hence, the conversation between the nonplayer characters NPC1 and NPC2 is of no interest to the user 1. The features that are controllable by the user 1 are the features that can be controlled by the user 1 by operating the hand-held controller 104. Examples of the features of the game include game state data. Examples of the game state data are provided below.

In one embodiment, a user is sometimes referred to herein as a player.

In an embodiment, the terms network account and user account are used herein interchangeably.

FIG. 2 is a diagram of an embodiment of a system 200 to illustrate nonplayer characters NPC1a and NPC2a generated while training the nonplayer characters NPC1 and NPC2 (FIG. 1). The nonplayer character NPC1a is the same as the nonplayer character NPC1 except that the nonplayer character NPC1a is being trained using an artificial intelligence (AI) model. For example, the nonplayer character NPC1a has the same look and feel as that of the nonplayer character NPC1 except that the nonplayer character NPC1a is controlled by the game cloud system to engage in a conversation with the nonplayer character NPC2a that is audible to the user 1 via the speakers and is related to the one or more virtual activities. Similarly, the nonplayer character NPC2a is the same as the nonplayer character NPC2 except that the nonplayer character NPC2a is being trained using the AI model. For example, the nonplayer character NPC2a has the same look and feel as that of the nonplayer character NPC2 except that the nonplayer character NPC2a is controlled by the game cloud system to engage in a conversation with the nonplayer character NPC1a that is audible to the user 1 via the speakers and is related to the one or more virtual activities.

Examples of a conversation between the nonplayer characters NPC1a and NPC2a that is related to the one or more virtual activities performed by the virtual character VC1 include a conversation regarding movement features generated from the game state data of the virtual scene 206. To illustrate, the conversation between the nonplayer characters NPC1a and NPC2a that is related to the one or more virtual activities includes a conversation regarding a manner of moving the virtual lasso 112, or a conversation regarding how the virtual character VC1 is to hold the virtual calf 110 before typing the virtual lasso 112 around the neck of the virtual calf 110, or a conversation regarding a virtual activity that is to be performed by the virtual character VC1 after accessing the virtual lasso 112, or a conversation regarding a virtual activity that is to be performed by the virtual character VC1 after tying the virtual lasso 112 around the neck of the virtual calf 110, or a combination thereof.

The user 1 operates the hand-held controller 104 to access a virtual scene 206 of the game via the user account 1 to enable training of the nonplayer characters NPC1 and NPC2. For example, the virtual scene 206 is the same as the virtual scene 106 (FIG. 1), except the virtual scene 206 includes the nonplayer characters NPC1a and NPC2a instead of the nonplayer characters NPC1 and NPC2.

The game cloud system modifies the nonplayer character NPC1 to generate the nonplayer character NPC1a according to training provided by the AI model to the nonplayer character NPC1. Moreover, the game cloud system modifies the nonplayer character NPC2 to generate the nonplayer character NPC2a according to training provided by the AI model to the nonplayer character NPC2. During a time period in which the user 1 controls the virtual character VC1 to perform the one or more virtual activities in the game, the game cloud system controls the nonplayer character NPC1a to perform one or more virtual acts that can modify, such as change, the one or more virtual activities to be performed by the virtual character VC1. For example, when the user 1 controls the hand-held controller 104 to access the virtual lasso 112, the game cloud system controls the nonplayer character NPC1a to output a statement, such as “Swing lasso first!”, via the one or more speakers of the computing device 102 that is audible to the user 1. A statement is sometimes referred to herein as a comment and is an example of a communication, such as an interaction. When the statement is output, the user 1 becomes interested, such as involved, in the game and controls the virtual character VC1 via the hand-held controller 104 and the user account 1 to swing the virtual lasso 112 before wrapping the virtual lasso 112 around the neck of the virtual calf 110 to catch the virtual calf 110. The swinging of the virtual lasso 112 is an example of one or more additional virtual activities performed by the virtual character VC1 and is an example of a feature in the game. As another example, the game cloud system controls the nonplayer character NPC1a to highlight the nonplayer character NPC1a. To illustrate, the nonplayer character NPC1a is highlighted by drawing a boundary around the nonplayer character NPC1a or changing a color of the nonplayer character NPC1a or changing a position of the nonplayer character NPC1a in the virtual scene 206 or a combination thereof. To further illustrate, the nonplayer character NPC1a is controlled by the game cloud system to perform a virtual motion, such as jump or dance or sway, and then output the statement, “Swing lasso first!”. The virtual motion of the nonplayer character NPC1a is an example of a communication, such as an interaction.

As yet another example, the game cloud system controls the nonplayer character NPC1a to output a statement, such as “Have a soda before catching the calf”, via the one or more speakers of the computing device 102 that is audible to the user 1. When the statement is output, the user 1 becomes interested, such as involved, in the game and accesses one or more features of the game via the hand-held controller 104 to obtain a virtual soda. After obtaining the virtual soda, the user 1 controls the virtual character VC1 to further control the virtual lasso 112 via the hand-held controller 104 to wrap the virtual lasso 112 around the neck of the virtual calf 110.

FIG. 3 is a diagram of an embodiment of the computing device 102 to illustrate a determination of interests of the user 1. The user 1 uses one or more input devices, such as the hand-held controller 104, coupled to the computing device 102 to access a social network account 1 assigned to the user 1 by a social network system, such as a server system. Examples of one or more input devices, as described herein, include a keyboard, a mouse, a keypad, a microphone, a touch screen, a stylus, and a combination thereof. Upon accessing the social network account 1, the user 1 operates the one or more input devices coupled to the computing device 102 to reply to a question from a social network friend of the user 1. The question is posed by the social network friend via a social network account assigned to the social network friend by the social network system. For example, the question includes “What do you enjoy about the lasso game?”. The reply includes that “I like to swing the lasso”. The question and the reply are stored by the social network system within a social network database within one or more memory devices of the social network system.

The AI model accesses social network data, such as the question and the reply, from the social network database of the social network system to determine the interests of the user 1. For example, the AI model parses the social network data to identify that the game is a lasso game and to further identify that the user 1 is interested in swinging the lasso. To illustrate, upon extracting words, such as, “like”, “swing”, and “lasso”, from the reply, the social network system determines that the user 1 is interested in swinging the lasso.

Based on the social network data, such as textual data or chat data or audio data, received via the social network account 1 or game state data of the game received via the user account 1 or any other data described herein or a combination thereof, the AI model is trained and the game cloud system controls the NPC1 or NPC2 or both the NPC1 and NPC2 based on the training of the AI model. For example, the game cloud system controls the NPC1 to state “Swing lasso first!” upon receiving a determination from the AI model of the interests of the user 1. The AI model determines the interests by analyzing the social network data. To illustrate, the AI model receives the game state data of the virtual scene 106 from the game cloud system. In the illustration, the AI model parses the game state data of the virtual scene 106 to determine that the NPC1 and NPC2 engage in the one or more virtual actions. The AI model also parses the game state data of the virtual scene 106 to determine that the virtual character VC1 is controlled to perform the one or more virtual activities and that the one or more virtual actions are performed by the NPC1 and NPC2 during the time period in which the one or more virtual activities are being performed. Further in the illustration, the AI model receives an indication from the user 1 via the computing device 102 and the user account 1 or from the social network data or the game state data of the virtual scene 106 that the one or more virtual actions performed by the NPC1 and NPC2 in the virtual scene 106 are boring, such as of no interest, to the user 1.

Examples of the game state data of the virtual scene 106 include data regarding virtual objects, such as virtual items, in the virtual scene 106. For instance, the game state data of the virtual scene 106 includes an identity of the NPC1, an identity of the NPC1, an identity of the virtual lasso 112, an identity of the virtual calf 110, an identity of the virtual character VC1, data indicating the one or more virtual actions performed by the NPC1 and the NPC2, and data indicating the one or more virtual activities performed by the virtual character VC1 in the virtual scene 106.

Continuing with illustration, the AI model receives the game state data of the virtual scene 206 from the game cloud system. In the illustration, the AI model parses the game state data of the virtual scene 206 to determine that the NPC1a engages in the one or more virtual acts. The AI model also parses the game state data of the virtual scene 206 to determine that the virtual character VC1 is controlled to perform the one or more virtual activities and that the one or more virtual acts are performed by the NPC1a during the time period in which the one or more virtual activities are being performed. Further in the illustration, the AI model receives an indication from the user 1 via the computing device 102 and the user account 1 or from the social network data or the game state data of the virtual scene 206 that the one or more virtual acts performed by the NPC1a are interesting to the user 1.

Examples of the game state data of the virtual scene 206 include data regarding virtual objects, such as virtual items, in the virtual scene 206. To illustrate, the game state data of the virtual scene 206 includes an identity of the NPC1a, an identity of the NPC2a, an identity of the virtual lasso 112, an identity of the virtual calf 110, an identity of the virtual character VC1, data indicating the one or more virtual acts performed by the NPC1a, and data indicating the one or more virtual activities performed by the virtual character VC1 in the virtual scene 206.

In one embodiment, instead of or in addition to the AI model receiving the indication from the user 1 via the hand-held controller 104 and the user account 1 that the one or more virtual acts performed by the NPC1a are interesting to the user 1, the AI model determines whether the one or more virtual acts performed by the NPC1a are of interest to the user 1 based on a response time of the user 1 to the one or more virtual acts. For example, the AI model calculates, using a clock source, a time interval between a time at which the statement, such as, “Swing lasso first!”, in the virtual scene 206, is output from the NPC1a and a time at which the virtual character VC1 is controlled by the user 1 via the hand-held controller 104 to swing the virtual lasso 112. In the example, the AI model compares the time interval with a predetermined time interval and upon determining that the time interval exceeds the predetermined time interval, the AI model determines the one or more virtual acts performed by the NPC1a are interesting to the user 1. In the example, on the other hand, upon determining that the time interval does not exceed the predetermined time interval, the AI model determines the one or more virtual acts performed by the NPC1a are boring to the user 1.

Further, in the embodiment, instead of or in addition to the AI model receiving the indication from the user 1 via the hand-held controller 104 and the user account 1 that the one or more virtual actions performed by the NPC1 and the NPC 2 are boring to the user 1, the AI model determines whether the one or more virtual actions performed by the NPC1 and the NPC 2 are of no interest to the user 1 based on a response time of the user 1 to the one or more virtual actions. For example, the AI model calculates, using the clock source, a time interval between a time at which the NPC1 and NPC2 engage in the conversation with each other and a time at which the virtual character VC1 is controlled by the user 1 via the hand-held controller 104 to wrap the neck of the virtual calf 110. In the example, the AI model compares the time interval with the predetermined time interval and upon determining that the time interval does not exceed the predetermined time interval, the AI model determines the one or more virtual actions performed by the NPC1 and NPC2 are boring to the user 1.

In one embodiment, instead of the reply, “I like to swing the lasso”, the reply is regarding a virtual environment of the virtual scene 106 or 206 (FIGS. 1 and 2). An example of the virtual environment includes a virtual background of the virtual scene 106 or 206. The virtual background includes one or more virtual objects, such as virtual mountains, virtual reverse, virtual sun, virtual stars, etc., that provide a background, such as a backdrop, to the virtual character VC1 and one or more nonplayer character, described herein. In the example, the question posed by the social network friend of the user 1 is regarding the virtual background. To illustrate, the question includes “What do you enjoy about the virtual background of the lasso game?”. The virtual background is an example of a feature of the game.

In an embodiment, instead of the reply, “I like to swing the lasso”, the reply is regarding a quest in the lasso game. An example of the quest includes achieving a goal, such as, capturing the virtual calf 110 or capturing a predetermined number of virtual calves, in the lasso game. The goal is provided by the game cloud system. In the example, the question posed by the social network friend of the user 1 is regarding the quest. To illustrate, the question includes “Do you enjoy catching the calf of the lasso game?”. The quest is an example of a feature of the game.

FIG. 4 is a diagram of an embodiment of the computing device 102 to illustrate a virtual scene 406 in which the NPC1a and NPC2a have been generated based on training of the AI model. The AI model is trained to determine interests of a user, such as the user 1. The virtual scene 406 is the same as the virtual scene 206 except that in the virtual scene 406, the virtual lasso 112 is wrapped around the neck of the virtual calf 110.

FIG. 5 is a diagram of an embodiment of a system 500 to illustrate training of an AI model 502, which is an example of the AI model. When the AI model 502 is trained, one or more nonplayer characters, such as NPC1 or NPC2 or NPC1a or NPC2a or a combination thereof, are trained. For example, the AI model is trained based on interests of one or more users, such as the user 1, a celebrity, and a famous person, and the game cloud system generates the one or more nonplayer characters based on the training of the AI model.

The system 500 includes a data parser 504, a textual data identifier 506, an audio data identifier 508, and a game context data identifier 510. Also, the system 500 includes a textual data classifier 512, an audio data classifier 514, and a game context data classifier 516. As an example, each of the AI model 502, the data parser 504, the textual data identifier 506, the audio data identifier 508, the game context data identifier 510, the textual data classifier 512, the audio data classifier 514, and the game context data classifier 516 is implemented in hardware or software or combination thereof. To illustrate, each of the AI model 502, the data parser 504, the textual data identifier 506, the audio data identifier 508, the game context data identifier 510, the textual data classifier 512, the audio data classifier 514, and the game context data classifier 516 is a computer program or a portion of a computer program. As another illustration, each of the AI model 502, the data parser 504, the textual data identifier 506, the audio data identifier 508, the game context data identifier 510, the textual data classifier 512, the audio data classifier 514, and the game context data classifier 516 is a controller, which is an example of a portion of a server system. An example of a controller includes a combination of a processor or a combination of the processor and a memory device. The processor of the controller is coupled to the memory device of the controller. Examples of a processor, as used herein, include an application specific integrated circuit, a central processing unit, and a programmable logic device, and these terms are used herein interchangeably. Examples of a memory device include a random access memory, a read-only memory, and a combination thereof.

The data parser 504 is coupled to the textual data identifier 506, which is coupled to the textual data classifier 512. Also, the data parser 504 is coupled to the audio data identifier 508, which is coupled to the audio data classifier 514. Furthermore, the data parser 504 is coupled to the game context data identifier 510, which is coupled to the game context data classifier 516. The textual data classifier 512, the audio data classifier 514, and the game context data classifier 516 are coupled to the AI model 502.

The data parser 504 receives textual data 518 from one or more text databases, audio data 520 from one or more audio databases, and game context data 522 from one or more game context databases. For example, the data parser 504 sends a request for permission to access to data stored in a network system, such as the social network system, or a chat network system, or a dating network system, or the game cloud system. To illustrate, the chat network system is a server system and the dating network system is a server system. An illustration of the dating network system is a dating app system. An example of the data stored in the network system include the textual data 518, or the audio data 520, or the game context data 522. Upon receiving the request, the network system sends a request to a user account for which the data is stored. The user account is assigned to a user, such as the user 1 or the celebrity or the famous person. The request sent to the user account is for access to the data. To illustrate, when the social network account 1 is used to generate the reply, illustrated in FIG. 3, the request is sent to the social network account 1. Continuing with the example, the user 1 uses the one or more input devices that are coupled to a computing device, such as the computing device 102, to provide an authorization to access the data from the user account. Upon receiving the authorization, the network system allows the data parser 504 to access the data stored in the network system. As another example, the data parser 504 sends a request to the network system to determine whether one or more user accounts from which the data stored in the network system is to be accessed is public or private. Upon receiving a response to the request indicating that the one or user accounts are public, the data parser 504 sends a request to access the data generated from the one or more user accounts. In response to receiving the request to access the data, the network system provides the access to the data. On the other hand, upon receiving a response to the request indicating that the one or more user accounts are private, the data parser 504 sends the request for permission to access to data stored in the one or more user accounts in the manner illustrated in the preceding example.

Examples of the textual data 518 include textual data stored within a text database of the social network system, or a text database of the chat network system, or a text database of the dating network system. The question to the user 1 and the reply provided by the user 1 in response to the reply, illustrated in FIG. 3, are examples of the textual data 518. Other examples of the textual data 518 include preferences of the user 1 or another user, such as the celebrity or the famous person, regarding one or more products or one or more services that are offered via the game. To illustrate, the textual data 518 includes a statement made within the dating network system or the chat network system by a user. In the illustration, the statement indicates a preference, such as “I like Coke™” or “I like to drink Pepsi™”, towards a beverage. The beverage is an example of a product. Other examples of the product include clothes, watches, shoes, phones, etc. As another illustration, the user 1 communicates with the celebrity within the chat network system and in response to the question, illustrated in FIG. 3, that is posed by the user 1, the celebrity provides the reply. The reply is also illustrated in FIG. 3. As yet another illustration, the user 1 communicates with the celebrity within the chat network system and in response to the question, illustrated in FIG. 3, that is posed by the celebrity, the user 1 provides the reply, also illustrated in FIG. 3. The data parser 504 is coupled to the social network system, the chat network system, and the dating network system.

Examples of the audio data 520 include audio data that is captured by a server system, such as the social network system, the chat network system, or the dating network system, or the game cloud system, or a combination thereof. To illustrate, the user 1 speaks into one or more microphones of the hand-held controller 104 to make the statement, such as, “I like to swing the lasso” in the lasso game and the one or more microphones generate the audio data 520 representing the statement. In the illustration, the audio data 520 representing the statement is stored in the server system. As another illustration, the user 1 speaks into the one or more microphones of the hand-held controller 104 to make a statement, such as, “This lasso game is too boring” or “the NPCs of this lasso game are too boring”, immediately after the two NPCs 1 and 2 engage in the boring conversation with each other. In the illustration, the audio data 520 representing the statement is stored in the server system.

Examples of the game context data 522 are provided above. Additional examples of the game context data 522 include game state data of the game that is captured by the game cloud system when another user, such as the celebrity or famous person, plays the game. To illustrate, the game context data 522 includes the data regarding the virtual objects in the virtual scene 106 and the data regarding the virtual objects in the virtual scene 206 when the game is accessed via a user account that is assigned to the celebrity.

It should be noted that access to a server system, such as the chat network system or the dating network system or the game cloud system, is provided to a user, described herein, via a user account that is assigned to the user. For example, the user 1 is assigned a chat network account by the chat network system and the user 1 logs into the chat network account to access the chat network system. As another example, the user 1 is assigned a dating network account by the dating network system and the user 1 logs into the dating network account to access the dating network system.

The data parser 504 accesses data, such as the textual data 518, the audio data 520, and the game context data 522, from one or more network systems via a computer network and parses, such as examines, the data to distinguish among the textual data 518, the audio data 520, and the game context data 522. For example, the data parser 504 accesses the data from one or more network systems to determine that an audio file in which the audio data 520 is stored is different from a text file in which the textual data 518 is stored. To illustrate, the data parser 504 accesses the audio file from a server system, described herein, and identifies from an extension, such as “.wav” or “.mp3”, of the audio file that the audio file includes the audio data 520. Similarly, the data parser 504 accesses the text file from a server system, described herein, and identifies from an extension, such as “.txt”, of the text file that the text file includes the text data 518. In a similar manner, the data parser 504 identifies a game context file that is accessed from the game cloud system from an extension of the game context file. The game context file includes the game context data 522. Examples of the computer network are provided below.

The data parser 504 further receives an identification of a network account, such as whether the network account is a social network account of the social network system or a game network account, such as a user account, of the game cloud system or a chat network account of the chat network system or a dating network account of the dating network system. An example of the game network account is a user account, such as the user account 1, of the game cloud system. The identification of the network account includes an identity of an account assigned to a user. For example, a network account that is assigned to the user 1 is different from, e.g., has different alphanumeric characters, compared to a network account that is assigned to the celebrity. The identification of the network account is received by the data parser 504 in conjunction with, such as during a contiguous time period, the reception of the textual data 518, or the audio data 520, or the game context data 522 that is created by accessing the network account. To illustrate, the identification of the network account is received by the data parser 504 as data within the same set of network protocol packets, such as transmission control protocol over Internet protocol (TCP/IP) packets, in which the textual data 518, or the audio data 520, or the game context data 522 is received. To further illustrate, a delay between receptions of any two of the packets of the set by the data parser 504 is less than a predetermined time period.

The data parser 504 provides the textual data 518 in conjunction with the identification of the network account to the textual data identifier 506, and the network account is accessed to generate the textual data 518. For example, the user 1 accesses the user account 1 to provide the reply, “I like to swing the lasso”, and the identification of the network account is sent from the data parser 504 to the textual data identifier 506 within a preset time interval from a time at which the textual data 518 is sent from the data parser 504 to the textual data identifier 506.

The textual data identifier 506 determines, from the textual data 518, one or more interests or lack of interest of a user, such as the user 1 or the celebrity, to generate a textual data output 524. For example, the textual data identifier 506 determines, from the reply by the user 1 via the social network account 1 to the question illustrated in FIG. 3, that the user 1 is interested in swinging the virtual lasso 112 (FIG. 1) during the game. To illustrate, the textual data identifier 506 identifies words, such as “lasso game” and “enjoy” in the question that is posed by the social network friend of the user 1 via a social network account of the social network friend and identifies words, such as “like”, “swing the lasso”, etc., from the reply, “I like to swing the lasso”, that is received via the social network account 1. The textual data identifier 506 compares the words with words stored within an online dictionary database to determine meanings of the words to further determine that the user 1 is interested in swinging the virtual lasso 112, which is an example of a feature of the lasso game. As another example, when the reply includes that the user 1 does not like to swing the lasso, the textual data identifier 506 determines that the user 1 is not interested in swinging the virtual lasso 112. As yet another example, in response to a query from a user received via the social network system and a social network account assigned to the user regarding which product or service is preferred by the celebrity, the celebrity indicates, via a social network account assigned to the celebrity, that the celebrity likes Coke™. An example of the textual data output 524 includes the meanings of the words of the textual data 518, and an indication as to whether a user, such as the user 1 or the celebrity or the famous person, is interested or disinterested, such as bored, by the features of the game or the product or the service.

The textual data output 524 is output from the textual data identifier 506 with the identification of the network account that is accessed to create the textual data 518, such as the reply to the question illustrated in FIG. 3. The textual data identifier 506 provides the textual data output 524 to the textual data classifier 512 in conjunction with the identification of the network account accessed to generate the textual data 518 of the textual data output 524. For example, the identification of the network account is sent from the textual data identifier 506 to the textual data classifier 512 within the preset time interval from a time at which the textual data output 524 is sent from the textual data identifier 506 to the textual data classifier 512.

The textual data classifier 512 classifies the textual data output 524 to output a textual data classification signal 526. For example, upon receiving the textual data output 524, the textual data classifier 512 identifies, from the textual data output 524, whether a user is interested or disinterested in the features of the game or the product or the service. Upon determining that the textual data output 524 indicates that the user is interested or disinterested, the textual data classifier 512 includes within the textual data classification signal 526 the indication of interest or lack thereof. On the other hand, upon determining that the textual data output 524 does not indicate that the user is interested or disinterested, the textual data classifier 512 queries a programmer of the AI model 502 or the AI model 502 to receive a response indicating that the user is interested or not interested based on the textual data 518. For example, the programmer provides the response indicating that the user is interested or not interested via an input device that is coupled to the textual data classifier 512. As an illustration, the programmer is the user 1 or another user. In the example, the textual data 518 is displayed by a processor of a computing device, such as the computing device 108, operated by the programmer to receive the response indicating whether the user is interested or disinterested. The textual data classifier 512 provides the textual data classification signal 526 including the indication whether the user is interested or not interested and including the meanings of the words received within the textual data output 524 to the AI model 502 to train the AI model 502.

The textual data classification signal 526 is sent from the textual data classifier 512 to the AI model 502 in conjunction with the identification of the network account used to generate the textual data 518. For example, the identification of the network account is sent from the textual data classifier 512 to the AI model 502 within the preset time interval from a time at which the textual data classification signal 526 is sent from the textual data classifier 512 to the AI model 502.

The data parser 504 provides the audio data 520 in conjunction with the identification of the network account to the audio data identifier 508, and the network account is accessed to generate the audio data 520. For example, the user 1 accesses the user account 1 and the one or more microphones of the hand-held controller 104 to provide the statement, “I like to swing the lasso”, or “This lasso game is too boring” or “the NPCs of this lasso game are too boring”. In the example, the one or more microphones generate the audio data 520 having data of the statement. To illustrate, the identification of the network account is sent from the data parser 504 to the audio data identifier 508 within the same set of network protocol packets in which the audio data 520 is sent. To further illustrate, a delay between any two of the packets having portions of the audio data 520 and the identification of the network account, and sent from the data parser 504 is less than the predetermined time period.

The audio data identifier 508 identifies meaning of the audio data 520, such as definitions of words or phrases or statements, that is received from the data parser 504. For example, the audio data identifier 508 analyzes, such as parses, meaning of the statement, such as, “This lasso game is too boring” or “the NPCs of this lasso game are too boring” or “I like to swing the lasso”, by comparing words of the statement of the audio data 520 with words or letters of the online dictionary to determine meanings of the words. Upon determining the meanings of the words, the audio data identifier 508 identifies the meaning of the audio data 520.

Upon identifying the meaning of the audio data 520, the audio data identifier 508 determines, from the audio data 520, one or more interests or lack of interest of the user 1 to generate an audio data output 528. For example, the audio data identifier 508 determines, from the reply, “I like to swing the lasso” received via the chat network account of the user 1, that the user 1 is interested in swinging the virtual lasso 112 (FIG. 1) during the game. In the example, the reply is, in response to the question, such as “What do you enjoy about the lasso game?”, posed by a chat network friend of the user 1 via a chat network account that is assigned to the chat network friend. To illustrate, the audio data identifier 508 identifies words, such as “lasso game” and “enjoy” in the question that is posed via the chat network account of the chat network friend of the user 1 and identifies words, such as “like”, “swing the lasso”, etc., from the reply “I like to swing the lasso” that is received via the chat network account of the user 1. The audio data identifier 508 compares the words with words stored within the online dictionary database to determine meanings of the words to further determine that the user 1 is interested in swinging the virtual lasso 112. As another example, when the reply, received via the chat network account of the user 1, includes that the user 1 does not like to swing the lasso, the audio data identifier 508 determines that the user 1 is not interested in swinging the virtual lasso 112. As yet another example, in response to a query from a user received via the chat network system and a chat network account assigned to the user regarding which product or service is preferred by the celebrity, the celebrity indicates, via a chat network account assigned to the celebrity, that the celebrity likes Sprite™. An example of the audio data output 528 includes the meanings of the words of the audio data 520, and an indication as to whether a user, such as the user 1 or the celebrity or the famous person, is interested or disinterested, such as bored, by the features of the game or the product or the service.

The audio data identifier 508 provides the audio data output 528 to the audio data classifier 514 in conjunction with the identification of the network account used to generate the audio data 520 of the audio data output 528. For example, the identification of the network account is sent from the audio data identifier 508 to the audio data classifier 514 within the preset time interval from a time which the audio data output 528 is sent.

The audio data classifier 514 classifies the audio data output 528 to output an audio data classification signal 530. For example, upon receiving the audio data output 528, the audio data classifier 514 identifies, from the audio data output 528, whether a user is interested or disinterested in the features of the game or the product or the service. Upon determining that the audio data output 528 indicates that the user is interested or disinterested, the audio data classifier 514 includes within the audio data classification signal 530 the indication of interest or lack thereof. On the other hand, upon determining that the textual data output does not indicate that the user is interested or disinterested, the audio data classifier 514 queries the programmer of the AI model 502 or the AI model 502 to receive a response indicating that the user is interested or not interested. For example, the programmer provides the response indicating that the user is interested or not interested via an input device that is coupled to the audio data classifier 514. In the example, the audio data 520 is output, via the one or more speakers, by the processor of the computing device, such as the computing device 108, operated by the programmer to receive the response indicating whether the user is interested or disinterested. The audio data classifier 514 provides the audio data classification signal 530 including the indication whether the user is interested or not interested and including the meanings of the words received within the audio data output 528 to the AI model 502 to train the AI model 502.

The audio data classification signal 530 is sent from the audio data classifier 514 to the AI model 502 in conjunction with the identification of the network account accessed by a user to generate the audio data 520 of the audio data classification signal 530. For example, the identification of the network account is sent from the audio data classifier 514 to the AI model 502 within the preset time interval from a time at which the audio data classification signal 530 is sent.

The data parser 504 provides the game context data 522 in conjunction with the identification of the network account to the game context data identifier 510. The network account is accessed to generate the game context data 522. For example, the user 1 accesses the user account 1 and uses the hand-held controller 104 to control the virtual character VC1 (FIG. 1) to swing or not swing the virtual lasso 112 before wrapping the virtual lasso 112 around the neck of the virtual calf 110. To illustrate, the identification of the network account is sent from the data parser 504 to the game context data identifier 510 within the same set of network protocol packets in which the game context data 522 is sent. To further illustrate, a delay between any two of the packets having portions of the game context data 522 and the identification of the network account, and sent from the data parser 504 is less than the predetermined time period.

The game context data identifier 510 identifies, such as determines, from the game context data 522, a meaning of the game context data 522. For example, the game context data identifier 510 compares a shape of the virtual lasso 112 (FIG. 1) with a predetermined shape of a virtual lasso to determine that the shape represents the virtual lasso 112. As another example, the game context data identifier 510 compares a motion of the virtual lasso 112 with a predetermined motion to determine that the user 112 ties the virtual lasso 112 around the virtual calf 110 (FIG. 1) without swinging the virtual lasso 112 first. Further, in the example, the game context data identifier 510 compares a shape of the nonplayer character NPC1 with a predetermined shape to determine that the virtual scene 106 (FIG. 1) includes the nonplayer character NPC1, compares a shape of the nonplayer character NPC2 with another predetermined shape to determine that the virtual scene 106 includes the nonplayer character NPC2, and identifies from the game state data that the audio data output from the nonplayer characters NPC1 and NPC2 does not mention the term “lasso” or is inaudible to determine that the nonplayer characters NPC1 and NPC2 engage in a conversation with each other and the conversation does not mention the term “lasso”. As another example, the game context data identifier 510 compares a shape of the nonplayer character NPC1a with a predetermined shape to determine that the virtual scene 206 (FIG. 2) includes the nonplayer character NPC1a, compares a shape of the nonplayer character NPC2a with another predetermined shape to determine that the virtual scene 206 includes the nonplayer character NPC2a, and identifies from the game state data that the audio data output from the nonplayer characters NPC1a and NPC2a mentions the term “lasso” determine that the nonplayer characters NPC1a and NPC2a engage in a conversation with each other and the conversation mentions the term “lasso”.

Upon determining the meaning of the game context data 522, the game context data identifier 510 determines, from the game context data 522, one or more interests or lack of interest of a user, such as the user 1 or the celebrity, to generate a game context data output 532. For example, in response to identifying that the nonplayer characters NPC1 and NPC2 engage in a conversation with each other that is inaudible and the virtual character VC1 does not swing the virtual lasso 112 before tying the virtual lasso 112 around the neck of the virtual calf 110 (FIG. 1), the game context data identifier 510 determines that the conversation is boring to the user 1. As another example, upon identifying that the nonplayer characters NPC1a and NPC2a engage in a conversation with each other that includes the term “lasso” and that the virtual character VC1 is controlled by the user 1 via the user account 1 and the hand-held controller 104 to tie the virtual lasso 112 around the neck of the virtual calf 110 after swinging the virtual lasso 112, the game context data identifier 510 determines that the user 1 is interested in swinging the virtual lasso 112. As yet another example, the game context data identifier 510 determines that the nonplayer character NPC1 outputs a statement, “I love Pepsi™”, and that in less than a prestored time interval from the time at which the statement is output, the virtual character VC1 is controlled by the user 1 via the hand-held controller 104 and the user account 1 to determine that the user 1 is not interested in Pepsi™. As another example, the game context data identifier 510 determines that the nonplayer character NPC1 outputs the statement, “I love Pepsi™” and that after the prestored time interval from the time at which the statement is output, the virtual character VC1 is controlled by the user 1 via the hand-held controller 104 and the user account 1 to determine that the user 1 is interested in Pepsi™.

The game context data identifier 510 provides the game context data output 532 to the game context data classifier 516 in conjunction with the identification of the network account accessed to generate the game context data 522 of the game context data output 532. For example, the identification of the network account is sent from the game context data identifier 510 to the game context data classifier 516 within the preset time interval from a time at which the game context data output 532 is sent from the game context data identifier 510 to the game context data classifier 516.

The game context data classifier 516 classifies the game context data output 532 to output a game context data classification signal 534. For example, upon receiving the game context data output 532, the game context data classifier 516 identifies, from the game context data output 532, whether a user is interested or disinterested in the features of the game or the product or the service. Upon determining that the game context data classifier 516 indicates that the user is interested or disinterested, the game context data classifier 516 includes within the game context data classification signal 534 the indication of interest or lack thereof. On the other hand, upon determining that the game context data output 532 does not indicate that the user is interested or disinterested, the game context data classifier 516 queries the programmer of the AI model 502 or the AI model 502 to receive a response indicating that the user is interested or not interested. For example, the programmer provides the response indicating that the user is interested or not interested via an input device that is coupled to the game context data classifier 516. In the example, the game context data 522 is displayed by the processor of the computing device, such as the computing device 108, operated by the programmer to receive the response indicating whether the user is interested or disinterested. The game context data classifier 516 provides the game context data classification signal 534 including the indication whether the user is interested or not interested and including the meanings of the game context data 522 to the AI model 502 to train the AI model 502.

The game context data classification signal 534 is sent from the game context data classifier 516 to the AI model 502 in conjunction with the identification of the network account accessed to generate the game context data 522. For example, the identification of the network account is sent from the game context data classifier 516 to the AI model 502 in less than the preset time interval from a time at which the game context data classification signal 534 is sent.

The AI model 502 is trained based on one or more of the textual data classification signal 526, the audio data classification signal 530, and the game context data classification signal 516. For example, upon determining that during greater than a predetermined number, such as a majority, of instances occurring during one or more chat sessions, replies made by the user 1 via the social network account 1 indicate that the user 1 likes to swing the lasso and upon determining that during greater than the predetermined number of instances occurring during one or more game sessions, the virtual character VC1 is controlled to tie the virtual lasso 112 within the predetermined time interval from a time at which the NPC1 and NPC2 engage in a conversation with each other, the AI model 502 determines that the user 1 is interested in swinging the virtual lasso 112 (FIG. 1) in the lasso game. In the example, upon determining that the user 1 is interested in swinging the virtual lasso 112, the AI model 502 communicates the determination to the game cloud system. Further, in the example, upon receiving the determination from the AI model 502, the game cloud system determines whether the user 1 is about to control the virtual character VC1 (FIG. 1) via the user account 1 and the hand-held controller 104 (FIG. 1) to access and tie the virtual lasso 112 around the neck of the virtual calf 110 (FIG. 1). A movement of the virtual character VC1 to access and tie the virtual lasso 112 around the neck of the virtual calf 110 is an illustration of a game state. Upon determining so, the game cloud system controls, such as triggers, one or more of the NPC1a and the NPC2a to output audio data in the form of sound to increase interest of the user 1 in the lasso game. To illustrate, a processor of the game cloud system accesses a protocol, such as a portion, within a game program of the game that was not accessed before training the NPC1a or NPC2a or both the NPCs 1a and 2a. The protocol is accessed from a memory device of the game cloud system. The protocol is executed by the processor of the game cloud system to output the audio data. An illustration of the audio data that is output from one or more of the NPC1a and the NPC2a include “Hey there! It will be fun to swing the lasso first before tying the calf!”, or “Swing lasso first!”. To further illustrate, when the NPC1a is controlled to output the audio data, the NPC1a is further controlled to look at the NPC2a as if the NPC1a is communicating with the NPC2a. As another further illustration, when the NPC2a is controlled to output the audio data, the NPC2a is further controlled to look at the NPC1a as if the NPC1a is communicating with the NPC2a. The one or more of the NPC1a and the NPC2a are controlled to output the audio data as sound via the one or more speakers of the computing device 102 (FIG. 1).

In the example, the greater than the predetermined number of instances occur during the same chat session or during multiple chat sessions. To illustrate, the user 1 mentions for multiple times during the chat session via the social network account 1 that the user 1 likes to swing the lasso. A chat session occurs between a login and a consecutive logout from a network account. The consecutive logout occurs after the login when there is no other logout between the consecutive logout and the login.

As another example, upon determining that during greater than the predetermined number of instances occurring during one or more game sessions, the virtual character VC1 is controlled to tie the virtual lasso 112 in less than the predetermined time interval from a time at which the NPC1 and NPC2 engage in a conversation with each other, the AI model 502 determines that the user 1 lacks interest in the lasso game. In the example, upon determining that the user 1 is not interested in the lasso game, the AI model 502 communicates the determination to the game cloud system. Further, in the example, upon receiving the determination from the AI model 502, the game cloud system determines whether the user 1 is about to control the virtual character VC1 to access and tie the virtual lasso 112 around the neck of the virtual calf 110. Upon determining so, the game cloud system controls, such as triggers, one or more of the NPC1a and the NPC2a to perform the virtual motion or output audio data in the form of the statement, “Swing virtual lasso!”, via the one or more speakers of the computing device 102 or a combination thereof, to increase interest of the user 1 in the lasso game.

As still another example, upon determining that during greater than the predetermined number of instances that occur within one or more game sessions, the virtual character VC1 is controlled to tie the virtual lasso 112 around the neck of the virtual calf 110 without swinging the virtual lasso 112 first after the nonplayer character NPC1a outputs the statement, “Swing lasso first!”, the AI model 502 is trained to determine that the user 1 is not interested in swinging the virtual lasso 112 during the lasso game. As an example, a game session of the lasso game occurs between a login and a consecutive logout from a network account. The consecutive logout occurs after the login when there is no other logout between the consecutive logout and the login.

As yet another example, in response to determining that during greater than the predetermined number of instances that occur within one or more game sessions, the virtual character VC1 is controlled, such as triggered, by user 1 via the hand-held controller 104 and the user account 1 to drink a virtual Pepsi™ after the nonplayer character NPC1a outputs a statement, “Drink some Pepsi™”, the AI model 502 is trained to determine that the user 1 is interested in Pepsi™ products. The virtual character VC1 is controlled by the user 1 to drink the virtual Pepsi™ immediately after the virtual character VC1 is controlled by the user 1 via the hand-held controller 104 and the user account 1 to access the virtual lasso 112 from a set of virtual tools offered by the lasso game. A movement of the virtual character VC1 to access the virtual lasso 112 is an example of a game state. In the example, the AI model 502 sends the determination that the user 1 is interested in Pepsi™ products to the game cloud system. Upon receiving the determination that the user is interested in Pepsi™ products and upon determining that the virtual character VC1 is to be controlled to tie the virtual lasso 112, the game cloud system controls one or more of the NPC1a and the NPC2a to perform the virtual motion, such as jump or sway, or output one or more additional statements describing additional virtual Pepsi™ or a combination thereof during one or more game sessions. The additional statements are output via the one or more speakers of the computing device 102. To illustrate, the processor of the game cloud system accesses a protocol, such as a portion, within a game program of the game that was not accessed before training the NPC1a or NPC2a or both the NPCs 1a and 2a. The protocol is executed by the processor of the game cloud system to output the one or more additional statements or the virtual motion or a combination thereof. The protocol is accessed from the memory device of the game cloud system. As another example, in response to determining that during greater than the predetermined number of instances that occur within one or more game sessions, the virtual character VC1 is controlled to tie the virtual lasso 112 without first drinking the virtual Pepsi™ after the nonplayer character NPC1a performs the virtual motion or outputs the statement, “Drink some Pepsi™” or a combination thereof, the AI model 502 is trained to determine that the user 1 is not interested in Pepsi™ products. It should be noted that when a protocol of the game program is not accessed by the processor of the game cloud system, the NPC1 or NPC2 or a combination thereof is not capable of performing the virtual motion performed by one or more of the NPC's 1a and 2a or provide the audio data output from one or more of the NPC's 1a and 2a.

In an embodiment, the AI model 502 is a portion of, such as integrated within, a game program of the lasso game.

In one embodiment, one or more of the data parser 504, the textual data identifier 506, the textual data classifier 512, the auto data identifier 508, the auto data classifier 514, the game context data identifier 510, and the game context data classifier 516 is implemented within the AI model 502. For example, functionality of one or more of the data parser 504, the textual data identifier 506, the textual data classifier 512, the auto data identifier 508, the auto data classifier 514, the game context data identifier 510, and the game context data classifier 516 is executed by the AI model 502.

In an embodiment, the functions described herein as being performed by the game cloud system are performed by one or more processors of the game cloud system.

In one embodiment, the terms processor and processing unit are used herein interchangeably. Examples of the processing unit include a graphical processing unit and a central processing unit.

FIG. 6 illustrates components of an example device 600, such as a client device or a server system, described herein, that can be used to perform aspects of the various embodiments of the present disclosure. An example of the client device is a computing device. This block diagram illustrates the device 600 that can incorporate or can be a personal computer, a smart phone, a video game console, a personal digital assistant, a server or other digital device, suitable for practicing an embodiment of the disclosure. The device 600 includes a CPU 602 for running software applications and optionally an operating system. The CPU 602 includes one or more homogeneous or heterogeneous processing cores. For example, the CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. The device 600 can be a localized to a player, such as a user, described herein, playing a game segment (e.g., game console), or remote from the player (e.g., back-end server processor), or one of many servers using virtualization in a game cloud system for remote streaming of gameplay to clients.

A memory 604 stores applications and data for use by the CPU 602. A storage 606 provides non-volatile storage and other computer readable media for applications and data and may include fixed disk drives, removable disk drives, flash memory devices, compact disc-read only memory (CD-ROM), digital versatile disc-ROM (DVD-ROM), Blu-ray, high definition-digital versatile disc (HD-DVD), or other optical storage devices, as well as signal transmission and storage media. The storage 606 is sometimes referred to herein as a memory device. User input devices 608 communicate user inputs from one or more users to other components of the device 600. Examples of the user input devices 608 include keyboards, mouse, joysticks, touch pads, touch screens, still or video recorders/cameras, tracking devices for recognizing gestures, and/or microphones. A network interface 614, such as a network interface controller (NIC), allows the device 600 to communicate with other computer systems via an electronic communications network, and may include wired or wireless communication over a computer network, such as local area networks and wide area networks. An example of a wide area network is the Internet. For example, when the device 600 is the client device, the client device communicates with the server system via the computer network. As another example, when the device 600 is the server system, the server system communicates with the client device via the computer network.

An audio processor 612 is adapted to generate analog or digital audio output, such as audio data, from instructions and/or data provided by the CPU 602, the memory 604, and/or data storage 606. The components of device 600, including the CPU 602, the memory 604, the data storage 606, the user input devices 608, the network interface 614, and an audio processor 612 are connected via a data bus 622.

A graphics subsystem 620 is further connected with the data bus 622 and the components of the device 600. The graphics subsystem 620 includes a graphics processing unit (GPU) 616 and a graphics memory 618. The graphics memory 618 includes a display memory (e.g., a frame buffer) used for storing pixel data for each pixel of an output image. The graphics memory 618 can be integrated in the same device as the GPU 616, connected as a separate device with the GPU 616, and/or implemented within the memory 604. Pixel data can be provided to the graphics memory 618 directly from the CPU 602. Alternatively, the CPU 602 provides the GPU 616 with data and/or instructions defining the desired output images, from which the GPU 616 generates the pixel data of one or more output images. The data and/or instructions defining the desired output images can be stored in the memory 604 and/or the graphics memory 618. In an embodiment, the GPU 616 includes three-dimensional (3D) rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from the graphics memory 618 to be displayed on the display device 610. The display device 610 can be any device capable of displaying visual information in response to a signal from the device 600, including a cathode ray tube (CRT) display, a liquid crystal display (LCD), a plasma display, and an organic light emitting diode (OLED) display. The device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a GPU since it will be doing a large number of relatively simple mathematical operations (e.g., matrix transformations). Other game engine segments that require fewer but more complex operations may be provisioned with a processing entity associated with one or more higher power CPUs.

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and an input/output (I/O) interface. The client device can be a personal computer (PC), a mobile phone, a netbook, a personal digital assistant (PDA), etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device system, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In an embodiment, although the embodiments described herein apply to one or more games, the embodiments apply equally as well to multimedia contexts of one or more interactive spaces, such as a metaverse.

In one embodiment, the various technical examples can be implemented using a virtual environment via a head-mounted display (HMD). The HMD can also be referred to as a virtual reality (VR) headset. As used herein, the term “virtual reality” (VR) generally refers to user interaction with a virtual space/environment that involves viewing the virtual space through the HMD (or a VR headset) in a manner that is responsive in real-time to the movements of the HMD (as controlled by the user) to provide the sensation to the user of being in the virtual space or the metaverse. For example, the user may see a three-dimensional (3D) view of the virtual space when facing in a given direction, and when the user turns to a side and thereby turns the HMD likewise, the view to that side in the virtual space is rendered on the HMD. The HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on the HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, compact disc-read only memories (CD-ROMs), CD-recordables (CD-Rs), CD-rewritables (CD-RWs), magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

It should be noted that in various embodiments, one or more features of some embodiments described herein are combined with one or more features of one or more of remaining embodiments described herein.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for generating nonplayer character (NPC) interactions according to player interests, comprising:
receiving data from one or more user accounts indicative of interest of a player;
training a nonplayer character in the game based on the data to output a trained nonplayer character;
determining whether a game state for triggering a communication from the nonplayer character is generated; and
controlling the trained nonplayer character to output the communication during the game upon determining that the game state is generated.

2. The method of claim 1, wherein the one or more user accounts include a gaming account of the player and a social network account of the player.

3. The method of claim 1, further comprising determining whether access to the data is permitted from the one or more user accounts, wherein said receiving the data occurs after determining that the access to the data is permitted.

4. The method of claim 1, wherein the data is indicative of the interest or lack thereof of the player in a feature of the game, wherein said controlling the trained player includes accessing a protocol of a game program not accessed before training the nonplayer character.

5. The method of claim 1, wherein the communication from the trained nonplayer character includes one or more motions by the trained nonplayer character performed during the game or a comment made by the trained nonplayer character during the game or a combination thereof.

6. The method of claim 5, wherein the one or more motions are not be performed by the nonplayer character and the comment cannot be made by the nonplayer character before said training the nonplayer character.

7. The method of claim 1, wherein said training the nonplayer character includes:
parsing the data to identify information regarding a feature of the game from the data, wherein the information is identified to output identified information;
classifying the identified information to determine whether the player has the interest in the feature, wherein the identifying information is classified to output classified information;
providing the classified information to an artificial intelligence (AI) model to train the AI model.

8. The method of claim 7, wherein the feature includes a virtual item in the game or an environment in the game or a quest in the game.

9. A server system for generating nonplayer character (NPC) interactions according to player interests, comprising:
a processor configured to:
receive data from one or more user accounts indicative of interest of a player;
train a nonplayer character in the game based on the data to output a trained nonplayer character; and
determine whether a game state for triggering a communication from the nonplayer character is generated; and
control the trained nonplayer character to output the communication during the game upon determining that the game state is generated; and
a memory device coupled to the processor.

10. The server system of claim 9, wherein the one or more user accounts include a gaming account of the player and a social network account of the player.

11. The server system of claim 9, wherein the processor is configured to determine whether access to the data is permitted from the one or more user accounts, wherein the data is received after determining that the access to the data is permitted.

12. The server system of claim 9, wherein the data is indicative of the interest of the player in a feature of the game, wherein to control the trained player, the processor is configured to access a protocol of a game program not accessed before the nonplayer character is trained.

13. The server system of claim 9, wherein the communication from the trained nonplayer character includes one or more actions by the trained nonplayer character performed during the game or a comment made by the trained nonplayer character during the game or a combination thereof.

14. The server system of claim 13, wherein the one or more actions cannot be performed by the nonplayer character and the comment cannot be made by the nonplayer character before the nonplayer character is trained.

15. The server system of claim 9, wherein to train the nonplayer character, the processor is configured to:
parse the data to identify information regarding a feature of the game from the data, wherein the information is identified to output identified information;
classify the identified information to determine whether the player has the interest in the feature, wherein the identifying information is classified to output classified information;
provide the classified information to an artificial intelligence (AI) model to train the AI model.

16. The server system of claim 15, wherein the feature includes a virtual item in the game or an environment in the game or a quest in the game.

17. A system for generating nonplayer character (NPC) interactions according to player interests, comprising:
a client device configured to receive, via one or more user accounts, data indicative of interest of a player;
a server coupled to the client device via a computer network, wherein the server is configured to:
access the data received via the one or more user accounts;
train a nonplayer character in the game based on the data to output a trained nonplayer character; and
determine whether a game state for triggering a communication from the nonplayer character is generated; and
control the trained nonplayer character to output the communication during the game upon determining that the game state is generated.

18. The system of claim 17, wherein the one or more user accounts include a gaming account of the player and a social network account of the player,
wherein the server is configured to determine whether access to the data is permitted from the one or more user accounts, wherein the data is received after determining that the access to the data is permitted,
wherein the data is indicative of the interests of the player in a feature of the game,
wherein the communication from the trained nonplayer character includes one or more actions by the trained nonplayer character performed during the game or a comment made by the trained nonplayer character during the game or a combination thereof,
wherein the one or more actions cannot be performed by the nonplayer character and the comment cannot be made by the nonplayer character before the nonplayer character is trained.

19. The system of claim 17, wherein to train the nonplayer character, the server is configured to:
parse the data to identify information regarding a feature of the game from the data, wherein the information is identified to output identified information;
classify the identified information to determine whether the player has the interest in the feature, wherein the identified information is classified to output classified information;
provide the classified information to an artificial intelligence (AI) model to train the AI model.

20. The system of claim 19, wherein the feature includes a virtual item in the game or an environment in the game or a quest in the game, wherein to control the trained player, the server is configured to access a protocol of a game program not accessed before the nonplayer character is trained.
